(19) United States
(12) Patent Application Publication
(10) Pub. No.: US 2002/0174161 A1
(43) Pub. Date: Nov. 21, 2002

(54) Java startup wrapper

(76) Inventors: Michael A. Scheetz, Fort Collins, CO (US); Humberto A. Sanchez II, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/859,423

(22) Filed: May 18, 2001

(51) Int. Cl. G06F 9/00; G06F 9/44; G06F 15/163

(52) U.S. Cl. 709/100; 709/311; 709/315

(57) ABSTRACT

An apparatus and method for shielding the end user from the complexities of initiating a Java program process in a command line interface shell to a computer operating system. The apparatus includes a command template to be applied to the Java program process, a module to implement the command template, and a module to execute the Java program process. The method includes the steps of instantiating a command line interface wrapper object, determining a requested Java class, calling a run method of a command template class to instantiate a JVM object; calling a main method of the requested Java class to execute within the JVM, and completing execution of the requested Java class. The apparatus and method allow a user to issue a command through a command line interface shell that then runs a Java program without the user having to manually start and initialize a JVM.

### TECHNICAL FIELD

The technical field relates to the execution of applications on a server and more particularly to a start-up wrapper for execution of a program written in the Java® programming language from within a command line interface.

### BACKGROUND

Over the past few years the Java® programming language has become the programming language of choice for large multi-system computer environments due to its portability across multiple computer hardware and operating system software platforms. In order to achieve their cross-platform functionality, programs written in the Java language require a specially segregated environment in which to run. To accomplish this, a Java Virtual Machine (“JVM”) is used to execute programs written in Java.

In the field of multiple-computer network systems, it is often necessary for a user or system administrator of a computer system linked to such a network to initiate or execute a system maintenance or administration application or process from a command line interface (“CLI”). Executing a program written in the Java programming language requires first starting a JVM for the Java program to run in. In essence, the Java program the user wishes to run becomes an argument in the command line invocation of the JVM. This solution exposes the user to some complexity in using the Java program. Another method of executing a Java program would be to use a shell script to execute a Java interpreter and Java program. This solution hides the complexity from the user, but may expose a potential system security weaknesses.

### SUMMARY

In one respect, what is described is an apparatus for shielding the end user from the complexities of initiating a Java program process in a command line interface to a computer operating system. The apparatus includes a command template to be applied to the Java program process, a module to implement the command template, and a module to execute the Java program process. The apparatus allows a user to issue a command through a command line interface that then runs a Java program without the user having to manually start and initialize a JVM. The user need not even be aware that the program being run by the command issued is a Java program or that a JVM has been started.

In another respect, what is described is a method for shielding the end user from the complexities of initiating a Java program process in a command line interface to a computer operating system. The method includes steps for instantiating an appropriate subclass of a command template class based on the executable command, starting a JVM, calling the main method of the requested Java class to execute within the JVM, and completing execution of the requested Java class. The method allows a user to issue a command through a command line interface that then runs a Java program without the user having to manually start and initialize a JVM. The user need not even be aware that the program being run by the command issued is a Java program or that a JVM has been started.

In yet another respect, what is described is a computer readable medium on which is embedded a program. The embedded program comprises components that execute the above method.

Those skilled in the art will appreciate these and other advantages and benefits of various embodiments of the invention upon reading the following detailed description of a preferred embodiment with reference to the below-listed drawings.

### BRIEF DESCRIPTION OF DRAWINGS

FIG. 1 is a block diagram of a network system on which a Java startup wrapper may be implemented.

FIG. 2 is a block diagram of a computer system on which a Java startup wrapper may be implemented.

FIG. 3 is a simplified static class diagram of elements of one embodiment of a Java startup wrapper system.

FIG. 4 is a flowchart illustrating the steps of one embodiment of a method for implementing a Java startup wrapper.

FIG. 5 is a flowchart illustrating the steps of another embodiment of a method for implementing a Java startup wrapper.

### DETAILED DESCRIPTION

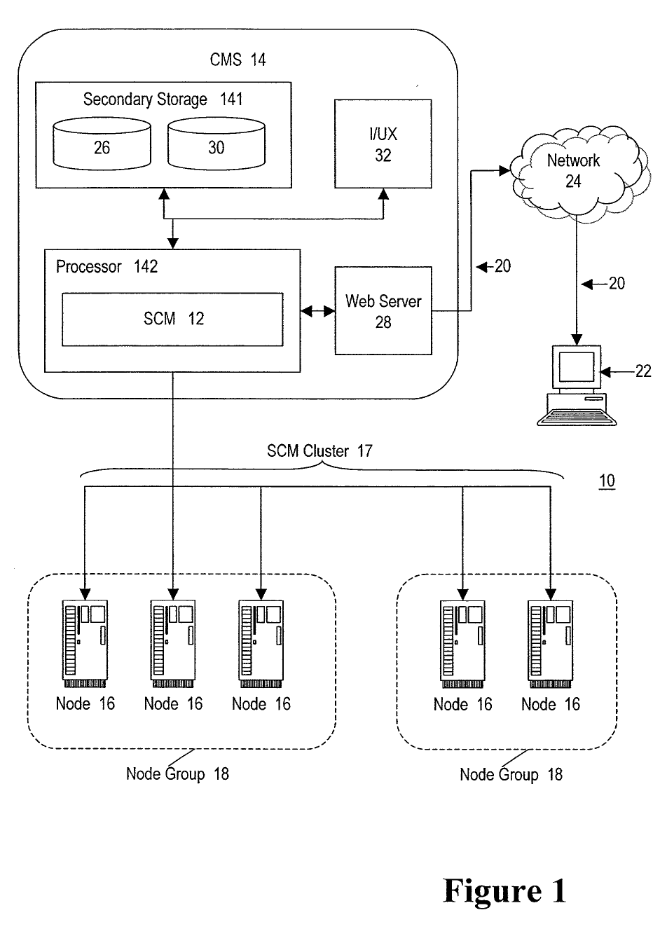

The apparatus and method disclosed herein may be used with computer systems employing a variety of operating system software to provide a startup wrapper for Java programs executed from a command line interface. FIG. 1 shows a network system 10 on which a Java startup wrapper may be run. The network system 10 comprises a ServiceControl Manager (“SCM”) 12 running on a Central Management Server (“CMS”) 14 and one or more nodes 16 managed by the SCM 12 on the CMS 14. Together the one or more nodes 16 managed by the SCM 12 make up a SCM cluster 17. A group of nodes 16 may be organized as a node group 18. A node 16 preferably comprises a server or other computer system.

The CMS 14 preferably is an HP-UX 11.x server running SCM 12 software. The CMS 14 includes a memory (not shown), a secondary storage device 141, a processor 142, an input device (not shown), a display device (not shown), and an output device (not shown). The memory, a computer readable medium, may include, RAM or similar types of memory, and it may store one or more applications for execution by processor 142, including the SCM 12 software. The secondary storage device 141, a computer readable medium, may include a hard disk drive, floppy disk drive, CD-ROM drive, or other types of non-volatile data storage. The processor 142 executes the SCM 12 software and other application(s), which are stored in memory or secondary storage, or received from the Internet or other network 24. The SCM 12 is programmed in Java® and operates in a Java® environment. For more on the SCM 12, see ServiceControl Manager Technical Reference, HP part number: B8339-90019, which is hereby incorporated by reference and which is accessible at http://www.software.hp.com/products/scmgr.

Generally, the SCM 12 supports managing a single SCM cluster 17 from a single CMS 14. All tasks performed on the SCM cluster 17 are initiated on the CMS 14 either directly or remotely, for example, by reaching the CMS 14 via a web connection 20. Therefore, a workstation 22 at which a user sits only needs the web connection 20 over a network 24 to the CMS 14 in order to perform tasks on the SCM cluster 17. The workstation 22 preferably comprises a display, a memory, a processor, a secondary storage, an input device and an out put device. In addition to the SCM 12 software and the HP-UX server described above, the CMS 14 preferably also comprises a data repository 26 for the SCM cluster 17, a web server 28 that allows web access to the SCM 12, a depot 30 comprising products used in the configuring of nodes, and an I/UX server 32. Java® objects operating in a Java® Virtual Machine (“JVM”) provide the functionality of the SCM 12.

Object-oriented programming is a method of programming that pairs programming tasks and data into re-usable chunks known as objects. Each object comprises attributes (i.e., data) that define and describe the object. Java classes are meta-definitions that define the structure of a Java object. Java classes, when instantiated, create instances of the Java classes and the instantiated Java classes are then considered Java objects. Methods within Java objects are called to get or set attributes of the Java object and to change a state of the Java object. Associated with each method is code that is executed when the method is invoked.

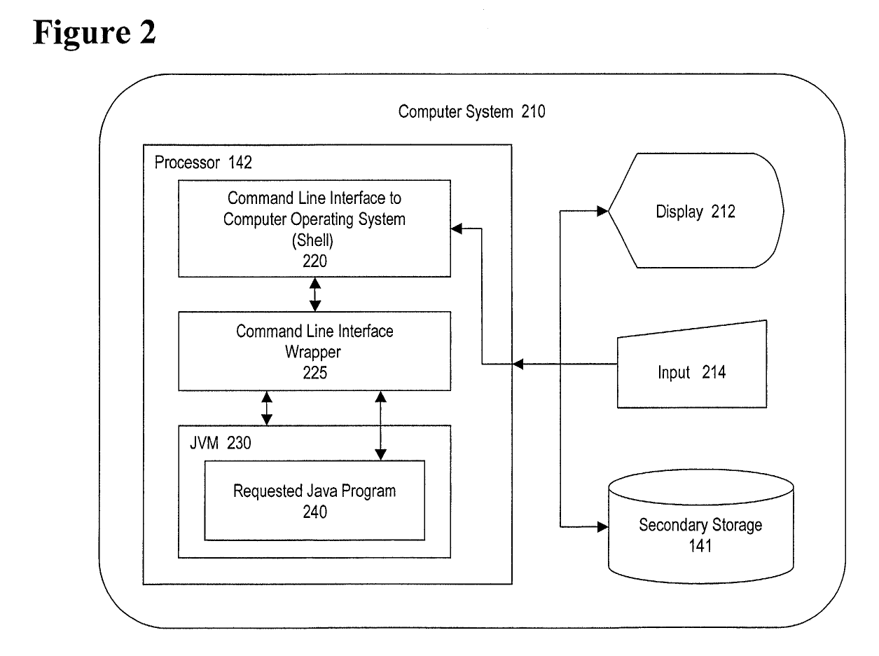

FIG. 2 shows a computer system 210 on which a Java startup wrapper may be implemented. The computer system 210 may be any one of the CMS 14 or the remote nodes 16. The computer system 210 includes the processor 142, a display 212, an input device 214, and the secondary storage 141. The processor 142 receives inputs from the input device 214 and displays outputs from the results of the actions of the processor 142 on the display 212. The processor 142 is operably connected to the secondary storage 141, allowing the processor 142 to request data and program code from the secondary storage 141 for use by the processor 142. The secondary storage 141 maintains permanent storage of program code and data for the computer system 210, including the various classes of Java code utilized by the present invention.

A server operating system (not shown) running on the processor 142 includes a command line interface shell 220 for receiving and displaying commands entered by users as a set of alphanumeric character strings and for displaying results from such commands. A command line interface wrapper 225 is connected to and communicates with the command line interface shell 220 running on the processor 142. The computer system 210 of FIG. 2 further includes a Java Virtual Machine (“JVM”) 230 running on the processor 142. When a SCM command entered by a user through the shell 220 requests execution of a Java program, the command line interface wrapper 225 initiates the JVM 230 and loads the requested Java program 240 into the JVM 230, where the Java program 240 executes and completes.

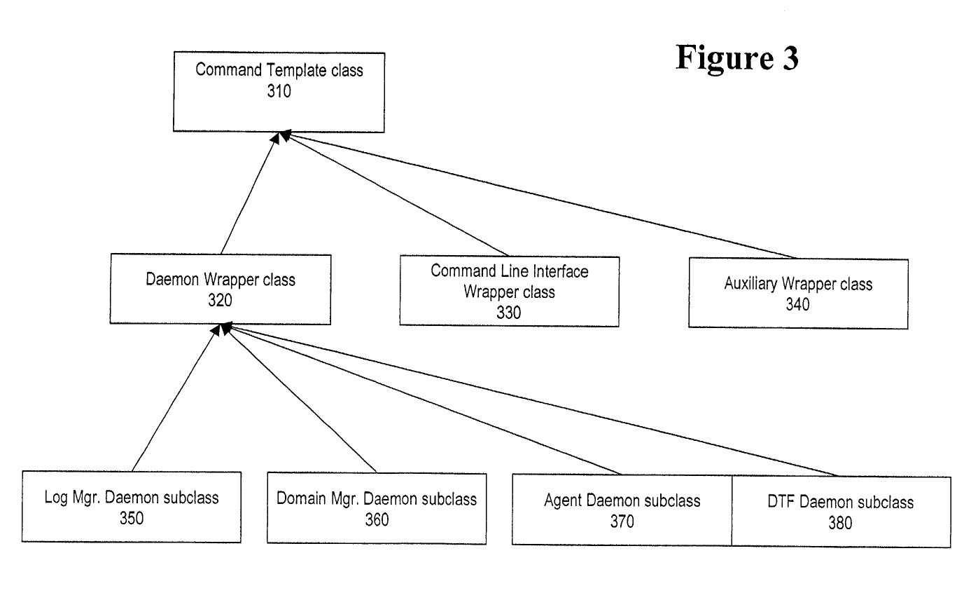

FIG. 3 is a simplified static class diagram. A Command Template class 310 is a base class that implements a template pattern for executing a Java program process from within a command line interface. The template method of process execution includes defining a skeleton of an algorithm in an operation and deferring selected steps to subclasses. The template method thus allows subclasses to redefine certain steps of an algorithm without changing the algorithm's structure. (see, “Design Patterns: Elements of Reusable Object-Oriented Software,” Gamma, et. al., Addison-Wesley Publishing Company, 1995, pp.325-330.). The Command Template class 310 is a C-class, a class written in the C or C++ languages, and does not require the JVM 230 to run.

The Command Template class 310 is inherited by a Command Line Interface (“CLI”) Wrapper class 330, an Auxiliary Wrapper class 340, and a Daemon Wrapper class 320. The object-oriented programming concept of inheritance allows reuse of the common functionality contained in one class, such as the Command Template class 310, and extend that functionality to the subclasses based on that class. The CLI Wrapper class 330, Auxiliary Wrapper class 340, and Daemon Wrapper class 320 are also each C-classes that do not require the JVM 230 to run. The CLI Wrapper class 330, Auxiliary Wrapper class 340, and Daemon Wrapper class 320 are each further subclassed, as exemplified by several classes shown inheriting the Daemon Wrapper class 320, including a Log Manager Daemon subclass 350, a Domain Manager Daemon subclass 360, an Agent Daemon subclass 370, and a Distributed Task Facility (“DTF”) Daemon subclass 380.

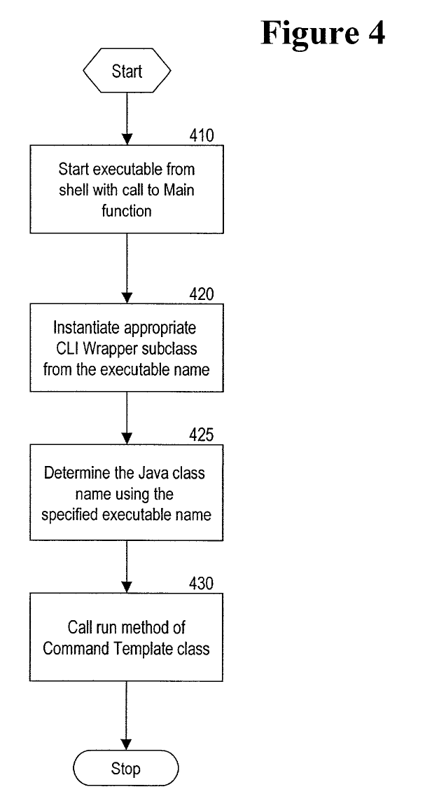

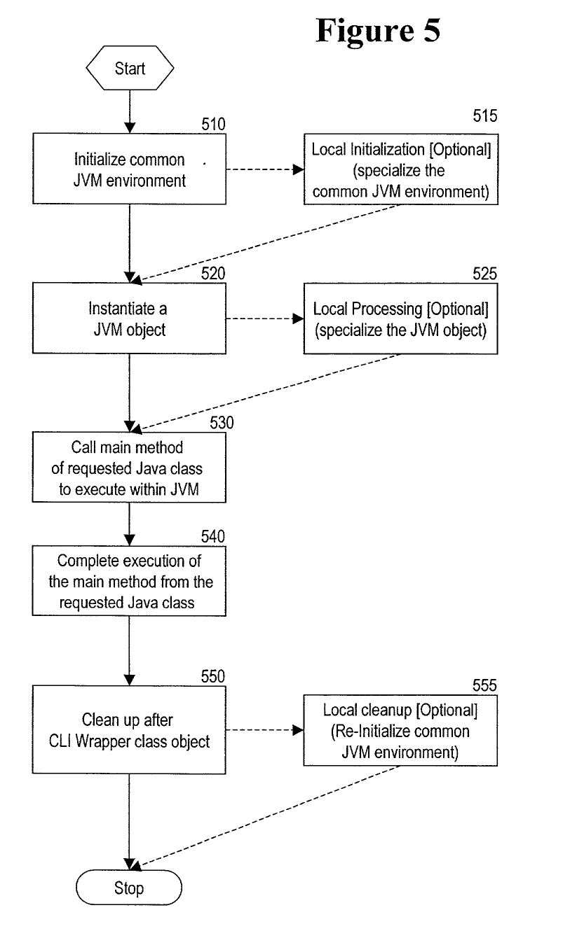

FIG. 4 is a flowchart illustrating the steps of one embodiment of a method 400 for implementing a Java startup wrapper. The method 400 operates to shield an end user from the complexities of initiating a program process in a command line interface to a computer operating system. The method 400 includes steps for instantiating an appropriate subclass of a command line interface (“CLI”) wrapper class (step 420), determining the Java class (step 425), and calling the run method of a command template class (step 430) from which the template steps of FIG. 5 are processed.

A standard C-class Main function of a CLI Wrapper executable 225 within the SCM 12 is the entry point for the method 400. Any execution of the method 400 will begin with a call to the main function of the CLI Wrapper executable 225 (step 410). The main function then issues a constructor call to the appropriate CLI Wrapper class 330, or utilizes another similar object creation technique, to instantiate, i.e., create an instance of, a CLI Wrapper object (step 420), determine the requested Java class (step 425), and then start the requested Java class 240 (step 430).

In a further embodiment of the Java startup wrapper, the main function may issue a constructor call to the Daemon Wrapper class 320 to instantiate a Daemon Wrapper object, determine and start the requested Java class 240. And, in another embodiment of the Java startup wrapper, the main function may issue a constructor call to the Auxiliary Wrapper class 340 to instantiate an Auxiliary Wrapper object, determine and start the requested Java class 240.

The CLI Wrapper executable 225 recognizes which subclass object needs to be instantiated from the name of the CLI Wrapper executable 225 delivered from the shell 220 (step 420). The name of the Java class is determined using a factory method design pattern as described in Gamma, et. al. (Step 425)

The name of the requested Java class 240 that will be loaded and called by the JVM 230, along with any command line arguments, is passed to a run method in the Command Template class 310 (step 430). This call begins execution of a JVM instantiation template embodied in the Command Template class 310. The method 400 then passes execution to the method 500.

FIG. 5 is a flowchart illustrating the steps of an embodiment of a further method 500 for implementing a Java startup wrapper. The method 500 operates as a process template that defines a skeleton of an algorithm and allows subclasses to redefine certain steps without changing the algorithm's structure. The method 500 includes steps for initializing common aspects of a JVM environment (step 510), e.g. setting the class path and shared library path variables used by the JVM; allowing subclasses to modify or add to the established common JVM environment (step 515); instantiating a JVM object (step 520); allowing subclasses to affect the JVM (step 525) prior to calling a main method of the requested Java class to execute within the JVM (step 530); and completing execution of the requested Java class (step 540). The method 500 also includes a step for performing any necessary cleanup by the CLI wrapper class object (step 550) after completing execution of the requested Java class, and allows subclasses to perform any other specialized cleanup tasks (step 555) prior to exiting the run method.

The JVM instantiation template in the Command Template class 310 initializes a common JVM environment (step 510) and allows the appropriate subclass associated with the requested Java class 240 to specialize the environment as needed (step 515). Typically this will at least include setting the class path and shared library path environment variables so the requested Java class 240 can find the Java class files and shared library files that it needs to run.

Once the common JVM environment is established, the JVM 230 is instantiated (step 520), and may be specialized as needed (step 525). Then the main method of the requested Java class 240 is called (step 530) to begin execution within the JVM 230. When the requested Java class 240 has completed (step 540), the CLI wrapper performs any needed cleanup (step 550), including any specialized cleanup issues (step 555) before exiting. Such cleanup may include destroying objects created by the method and no longer required to continue, including the JVM 230, resetting selected environment variables, and re-initializing the common JVM environment.

The steps of the method 400 and method 500 can be implemented with hardware or by execution of programs, modules or scripts. The programs, modules or scripts can be stored or embodied on one or more computer readable mediums in a variety of formats, such as source code, object code or executable code, for example. The computer readable mediums may include, for example, both storage devices and signals. Exemplary computer readable storage devices include conventional computer system RAM (random access memory), ROM (read only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the described methods can be configured to access, including signals downloaded through the Internet or other networks.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

What is claimed is:

1. An apparatus for shielding the end user of a computer system from the complexities of initiating a Java program process in a command line interface shell to a computer operating system, the apparatus comprising:
a command template to be applied to the Java program process;
a module to implement the command template; and
a module to execute the Java program process.

2. The apparatus of claim 1, wherein the module to implement the command template accepts user commands from the command line interface shell, wherein the user commands request execution of the Java program process.

3. The apparatus of claim 1, wherein the module to implement the command template initiates the module to execute the Java program process.

4. The apparatus of claim 1, wherein the module to implement the command template loads the Java program process into the module to execute the Java program process.

5. The apparatus of claim 1, wherein the module to execute the Java program process comprises a Java Virtual Machine (JVM).

6. The apparatus of claim 1, wherein the command template comprises program code and data written and executed in C++ programming language.

7. The apparatus of claim 1, wherein the module to implement the command template comprises program code and data written and executed in the C++ programming language.

8. A means for shielding the end user of a computer system from the complexities of initiating a Java program process in a command line interface shell to a computer operating system, the means comprising:
means for passing commands and data to and from a user and the computer operating system;
means for containing the Java program process; and
means for executing the Java program process.

9. The means of claim 8, wherein the containing means further comprises;
means for initializing the executing means;
means for configuring an operating environment for the Java program process; and
means for loading the Java program process into the executing means.

10. A method for shielding the end user of a computer system from the complexities of initiating a Java program process in a command line interface shell to a computer operating system, the method comprising the steps of:
instantiating a command line interface (“CLI”) wrapper object;
determining a requested Java class;
calling a run method of a command template class to instantiate a JVM object;
calling a main method of the requested Java class to execute in the JVM object; and
completing execution of the requested Java class.

11. The method of claim 10, wherein the step of instantiating a CLI wrapper object further comprises:
starting an executable from the command line interface shell by calling a main function; and
instantiating an appropriate subclass object.

12. The method of claim 10, wherein the step of calling the run method of the command template class to instantiate a JVM object further comprises:
initializing a common JVM environment; and
instantiating a JVM object.

13. The method of claim 10, wherein the completing step further comprises performing any necessary clean up by the CLI wrapper object after completing execution of the requested Java class.

14. The method of claim 13, wherein the completing step further comprises reinitializing the common JVM environment.

15. A computer readable medium on which is embedded a program, the program comprising modules that execute a method for shielding the end user of a computer system from the complexities of initiating a Java program process in a command line interface shell to a computer operating system, the method comprising the steps of:
instantiating a command line interface (“CLI”) wrapper object;
determining a requested Java class;
calling a run method of a command template class to instantiate a JVM object;
calling a main method of the requested Java class to execute in the JVM object; and
completing execution of the requested Java class.

16. The computer readable medium of claim 15, wherein the step of instantiating a CLI wrapper object further comprises:
starting an executable from the command line interface shell by calling a main function; and
instantiating an appropriate subclass object.

17. The method of claim 15, wherein the step of calling the run method of the command template class to instantiate a JVM object further comprises:
initializing a common JVM environment; and
instantiating a JVM object.

18. The method of claim 15, wherein the completing step further comprises performing any necessary cleanup by the CLI wrapper object after completing execution of the requested Java class.

19. The method of claim 18, wherein the completing step further comprises reinitializing the common JVM environment.
